(19) United States
(12) Patent Application Publication
(10) Pub. No.: US 2024/0047977 A1
(43) Pub. Date: Feb. 8, 2024

(54) Method and Apparatus for Operating a Balancing Method for a Stationary Battery Storage Means

(71) Applicant: Robert Bosch GmbH, Stuttgart (DE)

(72) Inventor: Michael Haas, Stuttgart (DE)

(21) Appl. No.: 18/359,993

(22) Filed: Jul. 27, 2023

(30) Foreign Application Priority Data
Aug. 2, 2022 (DE) 10 2022 207 964.7

(51) Int. Cl. H02J 7/00

(52) U.S. Cl. CPC H02J 7/0014; H02J 7/0048

(57) ABSTRACT

A method for operating an energy supply system having a stationary battery storage device includes operating the energy supply system and recording a chronological profile of an energy flow from the battery storage device and providing data points respectively indicative of a low-load duration and a timepoint within a period, wherein the low-load duration is indicative of a duration during which the amount of energy flow into or out of the battery storage device falls below a specified threshold. The method includes creating or further developing a data-based model based on the data points provided, wherein the data-based model is designed to determine at least one most likely timepoint within the period at which a balancing method can be performed without premature termination, and performing the balancing method at the at least one most likely timepoint.

### BACKGROUND

This application claims priority under 35 U.S.C. § 119 to patent application no. DE 10 2022 207 964.7, filed on Aug. 2, 2023 in Germany, the disclosure of which is incorporated herein by reference in its entirety.

The disclosure relates to methods for controlling balancing methods for stationary battery storage means, in particular measures for reducing the effects of balancing on the normal operation of battery storage means.

Stationary battery storage means are used as electrical energy storage means for autonomous or semi-autonomous operation of building facilities. Such stationary battery storage means typically comprise one or multiple battery packs, each comprising a plurality of battery cells.

During the course of operation, variations in the state of charge of the individual battery cells can occur in the course of operation due to manufacturing-based scattering, differently developing aging conditions of the individual battery cells, and serial scattering in the cell chemistry, which can lead to different terminal voltages. These pose a problem, particularly in the case of battery cells connected in parallel, which leads to a reduced efficiency of the battery system comprising the stationary battery storage means.

For the proper operation of the stationary battery storage means, it is therefore typical to perform what is referred to as a balancing method at certain times, when the states of charge of the individual battery cells are aligned with one another.

A balancing process can be performed either in accordance with an active balancing strategy, in which the charge is guided from a high-charge battery cell to a low-charge battery cell, or a passive strategy, in which the charge of battery cells having a high state of charge is converted into waste heat via a balancing resistor provided for this purpose and thus discharged, in order to align the states of charge with one another to the level of the battery cells having the lowest states of charge.

The conventional balancing strategy consists of a passive balancing method. Given that performance of the balancing method typically represents high stress on the relevant battery cells and the balancing resistors, it is advantageous to minimize the number of activation cycles for the balancing process as far as possible in order to achieve a longer lifetime of the stationary battery storage means.

In stationary battery storage means, a further aspect is the availability of use, because, during a balancing method, regular use, i.e., withdrawal or supply of electrical energy from or into the battery storage means, is blocked and the battery storage means is therefore disconnected from the consumers.

### SUMMARY

Provided according to the present disclosure is a method for operating a balancing method for a stationary battery storage means according to the disclosure as well as a corresponding apparatus and an energy supply system comprising a stationary battery storage means according to the disclosure.

Further embodiments are specified in the disclosure.

Provided according to a first aspect is a method for operating an energy supply system having a stationary battery storage means, said method comprising the following steps:
operating the energy supply system and recording a chronological profile of an energy flow from the battery storage means;
providing data points respectively indicative of a low-load duration and a timepoint within a period, wherein the low-load duration is indicative of a duration during which the amount of energy flow into or out of the battery storage means falls below a specified threshold;
creating or further developing a data-based model based on the provided data points, wherein the data-based model is designed to determine a most likely timepoint within the period, e.g., a week, at which a balancing method can be performed without premature termination;
performing the balancing method at one or multiple timepoints within the period that results according to the data-based model as the, or one of the, most likely timepoint(s) at which a balancing method can be performed without premature termination.

Stationary battery storage means are often used in energy supply systems that enable the stationary battery storage means to be charged using self-generated electrical energy, e.g., from a regenerative energy source, such as via a photovoltaic system, and to consume the stored energy by drawing from the battery storage means without having to draw energy from an electrical supply network.

Numerous strategies are known for operating the charging and drawing of electrical energy from stationary battery storage means able to be charged via a regenerative energy source. The balancing method must therefore preferably be performed when the energy flow from and into the stationary battery storage means is as low as possible in order to thus optimize the efficiency of the energy supply system. In particular, it is necessary to minimize the amount of energy drawn from the public supply network.

Given that the balancing method for stationary battery storage means typically requires a certain time during which no energy flow into or out of the stationary battery storage means is possible, there is a need to place the balancing method during a period in which energy flows into and out of the stationary battery storage means are as low as possible. However, these periods are not known in advance, and thus predictions must be made as to the time window in which the intensity of the battery use is as low as possible. However, due to its local nature, the chronological profile of the energy flows in an energy supply system with a stationary energy storage means is significantly dependent on the type of regenerative energy source, i.e., at what times it supplies electrical energy, as well as the consumption scheme of electrical consumers in the device to be supplied by the energy supply system.

According to the above method, it is therefore proposed to predict the times at which a balancing method can likely be performed without interruption using a data-based model that has been trained based on previous energy flow patterns in the energy supply system, in particular the pattern of energy withdrawal from the battery storage means. An optimal timing at which a balancing method can be performed can thus be determined.

This timing can be determined in that the energy drawn from the energy storage means falls below a specified threshold. Furthermore, as a further criterion, it can be considered that, at the timepoint of the energy excess from the regenerative energy source, i.e., the portion of the generated regenerative energy not consumed by itself, falls below a specified further threshold.

A data-based model containing a self-learning clustering method can be used in order to determine the at least one optimal timing for performing a balancing method. The clustering method can be based on a plurality of clustering algorithms, such as the Gaussian mixture method, affinity propagation, k-means, and the like.

For example, a k-means clustering algorithm can be performed which provides a specified number k of clusters in an input data space. For example, the specified number k can be specified based on prior knowledge or using an elbow method. Using the clusters found, the model then forms preferred, regularly recurring periods (e.g., by week) of specified low-load duration as a duration within a course of a week or another periodic unit of time of the energy withdrawal from the battery storage means, during which the energy withdrawal from the steady-state battery for the specified low-load duration falls consistently below the specified threshold.

Preferably, the input variables for the data-based model can include a low-load duration, time of day, and day of the week as characteristics of the input data space. Very short low-load durations of less than a specified duration, e.g. less than 1 minute, can be disregarded. One or multiple periodically recurring timepoints can therefore be determined at which the probability of a higher energy supply from the battery storage means is as low as possible over the specified threshold, and the balancing method can be started.

It can be provided that data points are provided only for low-load events having a low-load duration over a specified minimum duration, wherein the specified minimum duration is determined in particular depending on an average balancing duration of a balancing operation.

Using the clustering method, the specified number k and position of the clusters (relating to the considered input variables) can be determined. The number of data points of low energy withdrawal (defined by the low-load duration, the time of day, and the day of the week) in the clusters can indicate the importance of the respective cluster when making a decision to initiate a balancing method at the associated time of the week (day, time of day). Furthermore, the criterion can be specified that the low-load duration exceeds the specified minimum duration. The number of data points in the clusters can therefore be used as a criterion for operating a balancing method. By specifying the number of balancing methods to be performed within a week course (one time, two times, etc.), the cluster with the highest, the second highest, etc. number of data points can be selected.

For example, the relevant time can be determined from a timepoint (day of the week, time of day) of the centroid of the selected cluster.

In particular, the method described hereinabove for determining the optimized timepoint for a balancing method can then be performed as soon as a sufficient number of data points are present in the selected cluster. When the method is put into operation, or until a sufficient number of data points are in the selected cluster, the balancing method can be operated according to conventional methods according to a specified implementation schedule.

It can be provided that the balancing method is performed if a scattering threshold is exceeded by the scattering of states of charge of battery cells of the battery storage means. Therefore, it can be provided that the balancing method also starts at timepoints that deviate from the result of the data-based model when it is detected that the scattering of the states of charge of the battery cells is too high or exceeds the specified scattering threshold, which can be specified individually for a system.

Furthermore, the balancing method can be performed in case of blocked energy flows from or to the battery storage means. In the balancing method, the battery storage means can therefore be deactivated in order to thus disrupt energy flows from and to the stationary battery storage means.

In particular, the balancing method can be performed according to a specified chronological scheme for as long as the number of data points in the cluster with the highest number of data points falls below a specified frequency threshold.

The data-based model is continuously trained during operation of the energy supply system. By selecting an optimal timepoint to start a balancing method, the amount of energy drawn from the stationary battery storage means rather than the public supply network can be maximized. Further, the lifetime of the balancing resistors degraded by balancing operations can be maximized by minimizing the number of balancing operations over the entire battery lifetime.

If only one cluster with the maximum number of data points is selected, then a balancing method will take place only once a week.

In the event that the number of balancing operations to be performed within the period (e.g., weekly) is not sufficient for the clusters obtained, the balancing method can fall back on the procedure from the known prior art at any time. For example, if the charge difference between the battery cells exceeds a critical charge difference, then the balancing operation can therefore be started at the next timepoint determined according to conventional methods.

Furthermore, the time of day can be defined as the time of day and day of the week.

### BRIEF DESCRIPTION OF THE DRAWINGS

Embodiments are explained in greater detail hereinafter with reference to the accompanying drawings. Shown are:

FIG. 1 a schematic illustration of an energy system for a building having a stationary battery storage means and a photovoltaic system acting as a regenerative energy source;

FIG. 2 a diagram illustrating a chronological scheme of the energy flows for a building equipped with a photovoltaic system connected to the public supply network 7;

FIG. 3 a flowchart illustrating a method for operating the energy supply system of FIG. 2; and

FIG. 4 a schematic diagram for determining clusters for suitable timepoints for starting a balancing method.

### DETAILED DESCRIPTION

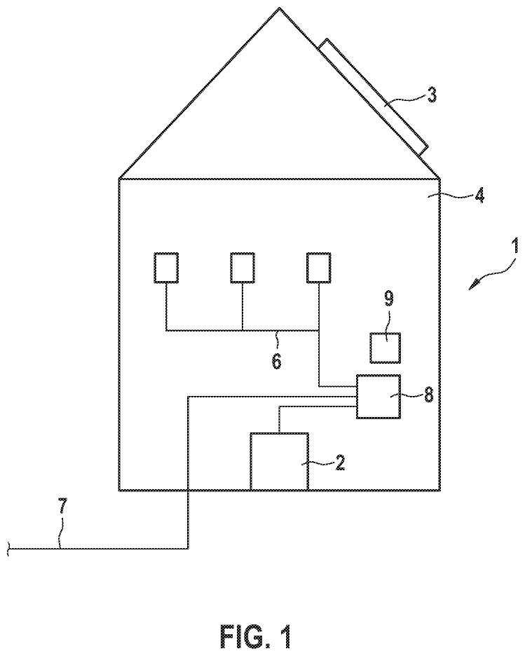

FIG. 1 shows a schematic representation of a building energy supply system as an example of a local energy supply system 1 for a building 4. The energy supply system comprises a stationary battery storage means 2 and a regenerative energy source 3, e.g., in the form of a photovoltaic system. One or multiple electrical consumers 5 are located in the building 4, which can be supplied with electrical energy from the stationary battery storage means via an internal supply network 6. In addition, the building 4 can be in communication with a public power supply network 7. The internal supply network 6, the battery storage means 2, and the public supply network 7 can communicate with one another via an inverter 8 used for controlling energy flows.

The energy flows in the energy supply system 1 are controlled via a control unit 9, so that electrical energy from the regenerative energy source 3 is preferably used by the consumers 5 in the building 4. If an excess of energy is available from the regenerative energy source 3, it is preferably stored in the stationary battery storage means 2 and only supplied to the public supply network 8 upon full charging of the stationary battery storage means 2. If no energy is available from the regenerative energy source 3, then the electrical energy from the stationary battery storage means 2 is first used before the energy supply from the public supply network 7 is used.

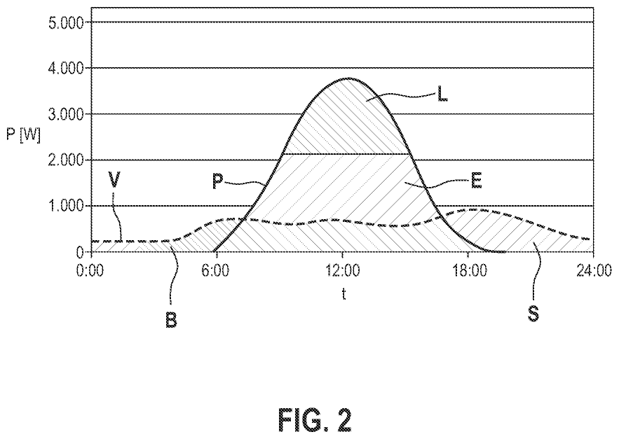

For example, a common chronological scheme of the energy flows for a building 4 equipped with a photovoltaic system connected to the public supply network 7 is shown in FIG. 2. The power consumption V is shown as a dashed line V and the availability of electrical energy from the regenerative energy source 3 is shown as a solid line P. The surface areas indicate the areas with the energy quantities used for charging the battery (area L), feeding into the public supply network 7 (area E), drawing energy from the public supply network 7 (area B), and self-consumption (area S) from the stationary battery storage means 2. This diagram can be different for different households and building uses, so an individual operating strategy must be provided.

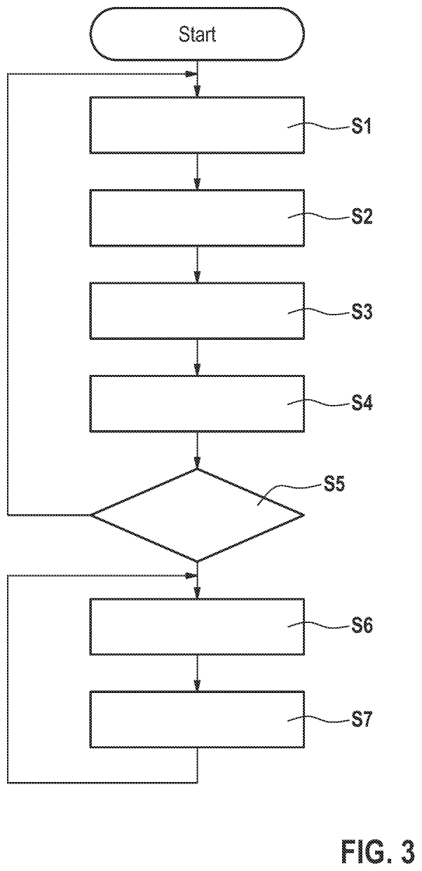

The flowchart of FIG. 3 shows a sequence of a possible method for operating the energy supply system 1 with respect to performing a balancing method for the stationary battery storage means 2. The balancing method provides an alignment of the states of charge of battery cells of stationary battery storage means 2 by discharging battery cells at a higher state of charge than the minimum state of charge of one of the battery cells via a corresponding balancing resistor until the states of charge of all battery cells are aligned. By way of example, the balancing method provided herein is intended to be performed once or twice per week.

In step S1, the energy supply system 1 is operated in accordance with a specified operating strategy. This strategy can generally provide that electrical energy from the regenerative energy source, e.g. the photovoltaic system, is used with the highest priority, the energy from the stationary battery storage means 2 is used with secondary priority, and the electrical energy from the public supply network 7 is used with the last priority.

In step S2, the balancing method is performed in a specified chronological scheme and/or depending on the excess of a scattering threshold of a scattering of states of charge of battery cells of the battery storage means 2. For example, in the event of a scattering of the states of charge of more than 5% between maximum and minimum state of charge of the individual battery cells, a balancing operation can be started.

In step S3, the energy flows are continuously monitored and, in particular, the energy flow from the stationary battery storage means 2 into the internal supply network 6 is determined.

Chronological phases are determined during which the energy flow from the stationary battery storage means falls below a specified threshold. The low-load duration during which this state is consistently maintained is also determined. The low-load duration ends at the timepoint of the specified threshold being exceeded by the flow of energy from the stationary battery storage means 2. If the low-load duration exceeds a specified minimum duration, then a data point is generated that is determined by the starting timepoint of the low-load duration as the time of day and day of week and the amount of the low-load duration. The variables of the data point then serve as inputs for a data-based model. The minimum duration selection is based on the balancing duration required for ending a balancing method and can be, e.g., 60 minutes, or in particular 1.5 times the average balancing duration.

At specified time intervals, in step S4, the data points determined from the operation of the energy supply system are analyzed according to a clustering method in order to determine clusters of frequencies of the data points. As a possible clustering method, k-means can be used in which the number k is determined, e.g., by means of an elbow method.

In step S5, the resulting clusters are checked and the number of data points per cluster is monitored for a specified frequency threshold. If the number of data points of at least one cluster exceeds the specified frequency threshold (alternative: yes), step S6 switches over to a schedule determined by the data-based model for performing the balancing methods. Otherwise, the previous mode of operation is maintained by jumping back to step S1.

During the further operation, the data-based model is accordingly continuously further developed so that further data points are added. At specified timepoints, the above clustering method is respectively performed in order to determine corresponding clusters with frequencies of data points.

In step S6, the schedule for performing the balancing method is determined to be one or multiple weekly timepoints corresponding to a specified balancing frequency by evaluating the data-based model. A number of clusters with the greatest number of data points are selected according to the balancing frequency. Thus, the cluster with the most data points, the cluster with the second most data points, etc., can be selected depending on whether a balancing method is to be performed once, twice, etc. per week.

With their centroids, the selected clusters provide the starting timepoint for a balancing operation, i.e., the day of the week and time of day assigned to the centroid.

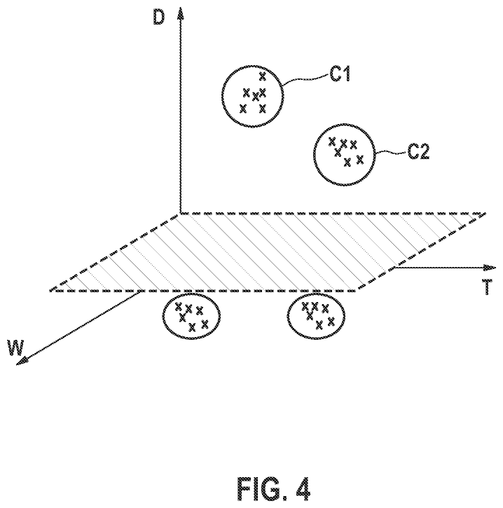

In FIG. 4, the result of a clustering method is shown by way of example. Clusters are shown with a plurality of data points, each indicative of the low-load duration D, the time of day T, and the day of the week W of a detected low-load event. In the illustrated example, a cluster C1 with a number of data points can be discerned, the centroid of which specifies the weekly timepoint Mondays 8:00 AM at a low-load duration of 80 min, and a cluster C2 with a number of data points, the centroid of which specifies the weekly timepoint Friday 11:00 PM at a duration of 70 min. The shaded surface is indicative of the surface area representing the threshold for the low-load duration. A balancing method is not intended to be started for clusters that are below this surface, as the duration until the threshold is exceeded by the amount of energy flow is probably not sufficient to end the balancing method.

In step S7, the energy supply system is operated in the manner described above, in which case the balancing operations are started at the starting timepoints determined by the data-based model.

In addition to performing the balancing method at the timepoint determined using the data-based model, a monitoring of the scattering of the states of charge can be performed, so that if the scattering of the states of charge is too large, a balancing method is to be started regardless of the timepoint(s) determined by the data-based model.

What is claimed is:

1. A method for operating an energy supply system having a stationary battery storage device, comprising:
operating the energy supply system and recording a chronological profile of an energy flow from the battery storage device;
providing data points respectively indicative of a low-load duration and a timepoint within a period, wherein the low-load duration is indicative of a duration during which an amount of the energy flow into or out of the battery storage device falls below a specified threshold;
creating or further developing a data-based model based on the data points provided, wherein the data-based model is designed to determine at least one likely timepoint within the period at which a balancing method can be performed without premature termination; and
performing the balancing method at the at least one likely timepoint.

2. The method according to claim 1, wherein the balancing method is performed based upon blocked energy flows from or to the battery storage device.

3. The method according to claim 1, wherein the balancing method is performed based upon exceeding a scattering threshold with scattering of states of charge of battery cells of the battery storage device.

4. The method according to claim 1, wherein:
the data-based model comprises a clustering method;
the provided data points are clustered;
each cluster is associated with a starting timepoint for starting a balancing method; and
the starting timepoint of each cluster corresponds to a centroid of the respective cluster.

5. The method according to claim 4, wherein the balancing method is performed according to a specified chronological scheme for as long as a number of data points in the cluster with the highest number of data points falls below a specified frequency threshold.

6. The method according to claim 1, wherein the at least one likely timepoint is defined as a time of day and a day of the week.

7. The method according to claim 1, wherein;
data points are provided only for low-load events having a low-load duration over a specified minimum duration; and
the specified minimum duration is determined depending on an average balancing duration of a balancing operation.

8. The method according to claim 1, wherein;
the at least one likely timepoint comprises a most likely timepoint at which the balancing method can be performed without premature termination; and
performing the balancing method comprises performing the balancing method at the most likely timepoint at which the balancing method can be performed without premature termination.

9. An apparatus for operating an energy supply system having a stationary battery storage device, wherein the apparatus is designed to:
operate the energy supply system and detect a chronological profile of an energy flow from the battery storage device;
provide data points respectively indicative of a low-load duration and a timepoint within a period, wherein the low-load duration is indicative of a duration during which the amount of energy flow into or out of the battery storage device falls below a specified threshold;
create or further develop a data-based model based on the provided data points, wherein the data-based model is designed to determine at least one most likely timepoint within the period at which a balancing method can be performed without premature termination; and
perform the balancing method at one or multiple timepoints within the period that results according to the data-based model as the at least one most likely timepoint at which a balancing method can be performed without premature termination.

10. A computer program product comprising commands that, when the program is executed by at least one data processing device, cause the at least one data processing device to perform the method according to claim 1.

11. A machine-readable storage medium comprising commands that, when executed by at least one data processing device, cause the at least one data processing device to perform the method according to claim 1.
